(19) United States
(12) Patent Application Publication
(10) Pub. No.: US 2026/0057581 A1
(43) Pub. Date: Feb. 26, 2026

(54) SYNTHETIC DATA GENERATION USING CONDITIONING INPUTS AND TEXTUAL DESCRIPTIONS

(71) Applicant: NVIDIA Corporation, Santa Clara, CA (US)

(72) Inventors: Kezhao CHEN, Shanghai (CN); Ruiqi ZHAO, Shanghai (CN); Tingting LIANG, Beijing (CN)

(73) Assignee: NVIDIA Corporation, Santa Clara, CA (US)

(21) Appl. No.: 18/816,503

(22) Filed: Aug. 27, 2024

(30) Foreign Application Priority Data
Aug. 23, 2024 (CN) 202411172323.9

(51) Int. Cl. G06T 11/60; G06T 7/12; G06T 7/13; G06V 10/25; G06V 10/44

(52) U.S. Cl. CPC G06T 11/60; G06T 7/12; G06T 7/13; G06V 10/25; G06V 10/44

(57) ABSTRACT

In various examples, systems and methods are disclosed that relate to the generation of synthetic data. For example, a system may receive data associated with an initial image representing an environment of a vehicle during operation, generate an input control map based at least on the initial image, and provide the input control map and a text input to a model. The model may then generate an augmented image based at least on the input control map and the text input. In examples, the text input represents a text prompt associated with one or more image features to include when generating the augmented image. The augmented images can then be used to train or update systems such as perception systems involved in object classification by autonomous or semi-autonomous vehicles.

### CROSS-REFERENCE TO RELATED APPLICATIONS

The present application claims the benefit of and priority to Chinese Patent Application No. 202411172323.9, filed Aug. 23, 2024, the disclosure of which is incorporated herein by reference in its entirety.

### BACKGROUND

Systems that implement generative models can generate images in response to receiving strings of text as input. As an example, the string “a car driving down the road” may be provided to a generative model to cause it to generate and output images of cars driving down a road, the images representing the car in a variety of poses, on a variety of streets, etc. But while these images may be useful for general applications, such as the creation of aesthetically pleasing images, they are typically less useful when included in datasets curated for specific applications such as training or updating perception systems involved in vehicle automation. This is because most (if not all) of the images generated by the model may represent unrealistic driving scenarios, and training perception systems using these unrealistic images may result in little to no improvement to the system's ability to classify objects, and even possible regression of the system's abilities.

### SUMMARY

Embodiments of the present disclosure relate to the generation of synthetic data from images and text for use in developing perception systems for, for example, automated vehicle systems and applications. In contrast with conventional systems, such as those described above, the systems and methods described herein implement certain techniques that control the output of a model (e.g., a generative model or any other suitable model). By controlling the output of the model based at least on these techniques, these systems and methods can ensure that the images represent real-world scenarios corresponding to a specific domain (e.g., the automated vehicle domain and/or other domains that rely on the use of image-based training datasets). These datasets can then be used to train and/or update perception systems involved in object classification.

At least one aspect relates to a processor. The processor can include one or more circuits to obtain data associated with an initial image. In some implementations, the initial image can depict a first set of one or more image features and represent an environment of a vehicle. The one or more circuits can generate an input control map based at least on the initial image. The one or more circuits can provide the input control map and a text input to a neural network to cause the neural network to generate an augmented image that includes a second set of one or more image features. In some implementations, the text input represents a text prompt associated with the second set of one or more images features. In some implementations, the one or more features can be different from the first set of one or more features.

In some implementations, the one or more circuits can update an initial dataset based at least on data associated with the augmented image. The initial dataset may include the data associated with the initial image. In some implementations, the one or more circuits can generate a second dataset based at least on data associated with the augmented image.

In some implementations, the one or more circuits can determine one or more labels and one or more bounding boxes associated with the first set of one or more image features to augment in the initial image. In some implementations, the one or more labels correspond to the one or more bounding boxes. In some implementations, the one or more circuits can determine the text prompt based at least on the one or more labels and one or more bounding boxes associated with the first set of one or more image features to augment in the initial image.

In some implementations, when generating the input control map, the one or more circuits can determine one or more splines associated with the initial image and generate the input control map based at least on the one or more splines associated with the initial image. In some implementations, when generating the input control map, the one or more circuits can determine one or more edges associated with the initial image and generate the input control map based at least on the one or more edges associated with the initial image. In some implementations, when generating the input control map, the one or more circuits can determine one or more image masks associated with the initial image and generate the input control map based at least on the one or more image masks associated with the initial image. In some implementations, when generating the input control map, the one or more circuits can determine one or more segmentation masks associated with the initial image and generate the input control map based at least on the one or more segmentation masks associated with the initial image. In some implementations, the segmentation masks are associated with an object type in an environment.

In some implementations, when generating the second dataset, the one or more circuits can determine a correspondence between the initial image and the augmented image and generate the second dataset based at least on the augmented image and the correspondence between the initial image and the augmented image.

In some implementations, the one or more circuits can receive data associated with user input from a user, the user input representing an image mask, and generate the input control map based at least on the image mask and the initial image. In some implementations, the one or more circuits can select the text prompt from among a plurality of text prompts. In some implementations, the one or more circuits can select the text prompt from among the plurality of prompts based at least on one or more segmentation masks associated with the initial image.

In some implementations, the neural network is a stable diffusion model. In some implementations, when providing the input to the stable diffusion model, the one or more circuits can cause the stable diffusion model to provide as output the augmented image based at least on the input control map and the text prompt.

At least one aspect relates to a system. The system can include one or more processing units to perform operations (e.g., image processing, and/or control operations for an autonomous or semi-autonomous vehicle, robot, or machine). In some implementations, the operations include obtaining data associated with an initial image. The initial image depicting a first set of one or more features of an environment of a vehicle (or robot, machine, etc., henceforth collectively “vehicle”) during operation. In some implementations, the operations include generating an input control map based at least on the initial image. In some implementations, the operations include providing the input control map and a text input to a neural network to cause the neural network to generate an augmented image depicting a second set of one or more image features. The text input can represent a text prompt associated with the second set of one or more image features, the second set of one or more image features being different from the first set of one or more image features in the initial image. In some implementations, the operations include updating an initial dataset based at least on data associated with the augmented image, the initial dataset comprising the data associated with the initial image. In some implementations, the operations include generating a second dataset based at least on data associated with the augmented image.

At least one aspect relates to a method. In some implementations, the method includes receiving, using one or more processing units of a machine, data associated with an initial image. The initial image can depict a first set of one or more image features and represent an environment. In some implementations, the method includes generating, using the one or more processing units of the machine, an input control map based at least on the initial image. In some implementations, the method includes providing, using the one or more processing units of the machine, the input control map and a text input to a model to cause the model to generate an augmented image depicting a second set of one or more image features. The text input can represent a text prompt associated with the second set of one or more image features. The second set of one or more image features can be different from the first set of one or more image features. In some implementations, the method includes updating, using the one or more processing units of the machine, an initial dataset based at least on data associated with the augmented image, the initial dataset comprising the data associated with the initial image.

### BRIEF DESCRIPTION OF THE DRAWINGS

The present systems and methods for generating synthetic data from images and text are described in detail below with reference to the attached drawing figures, wherein:

FIG. 1 is a block diagram of an example system for preprocessing images, in accordance with some embodiments of the present disclosure;

FIGS. 2A and 2B are block diagrams of example systems for generating synthetic data from images and text, in accordance with some embodiments of the present disclosure;

FIG. 3 is a flow diagram of an example method for generating synthetic data from images and text, in accordance with some embodiments of the present disclosure;

FIG. 4 is a diagram of an example initial image and corresponding feature maps, in accordance with some embodiments of the present disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

Systems and methods are disclosed that relate to the generation of synthetic data from images and text. It will be understood that, although various implementations are described in association with the training and/or updating of datasets used to develop driving automation systems (defined by a taxonomy developed by the Society of Automotive Engineers (SAE International) spanning Levels 0-6) the systems and methods described herein, as well as the techniques they implement, may be applied to a variety of other domains including those involving the development of robotic systems installed on vehicles (e.g., boats, aircraft, agricultural and farming equipment, and/or the like) that automate one or more functions typically performed by human operators. In addition, although the present disclosure may be described with respect to perception systems (e.g., systems involved in classifying objects based at least on images generated by sensors during vehicle operation), this is not intended to be limiting, and the systems and methods described herein, as well as the techniques they implement, may be used in augmented reality, virtual reality, mixed reality, simulation, and other similar systems where the controlled generation of images for model training and/or updating is involved.

With continued reference to driving automation systems, many partial (SAE L2), conditional (L3), and high (LA) driving automation systems require extremely large datasets to train the models (e.g., machine learning models, neural networks, and/or the like) they rely on. For example, to develop a vision-based system that can classify objects included in images captured by sensors (e.g., cameras) installed on a vehicle, thousands of individual images must first be collected while a vehicle is driven in various environments and conditions. These images are then inspected by humans and annotated with tags representing objects or agents found in the image. The resulting set of images and corresponding tags can be used to update the dataset that is then used to train/update models to classify objects or agents.

But these datasets can lack the diversity of environments and situations needed to train the machine learning model to classify objects and agents with an appropriate degree of reliability. As an example, a vehicle can be driven to collect images for hundreds of hours on an interstate highway, but rarely will that vehicle encounter objects such as fire hydrants or bicycles. As another example, the vehicle can be driven day and night, but in some environments will only encounter certain agents like pedestrians and children with regularity during the day. To address this lack of diversity, some developers will accumulate thousands or millions of miles until a diverse enough set of images are obtained to annotate and use to train the vision-based system. This is an expensive, time and resource-intensive process. Others may use simulators for training, but generating high-fidelity synthetic datasets can be difficult.

In some implementations, the systems and methods described herein can generate and/or augment datasets to include representations of less frequently encountered objects and agents. More specifically, embodiments of the disclosed systems and methods involve receiving a dataset (e.g., sets of images captured during vehicle operation), preprocessing the images to generate an input control map (e.g., a feature map and/or the like) and associating a prompt with each image input control map (the prompt indicating how to generate an augmented version of the image in coordination with the input control map), and providing the image input control map and prompt to a model. That model then outputs an augmented image which includes, excludes, and/or changes certain objects or agents identified by the prompt. By implementing the disclosed approach, the amount of time needed to operate vehicles so as to collect images for training purposes can be reduced significantly. Further, images can be augmented via post-processing, to target certain performance improvements. For example, in the case where a certain model is classifying motorcyclists with a lower degree of accuracy than bicyclists, the presently disclosed techniques can be used to generate a dataset with more images of motorcyclists that, in turn, can be used to fine-tune the machine learning model and improve performance while forgoing processing of non-relevant portions of large datasets.

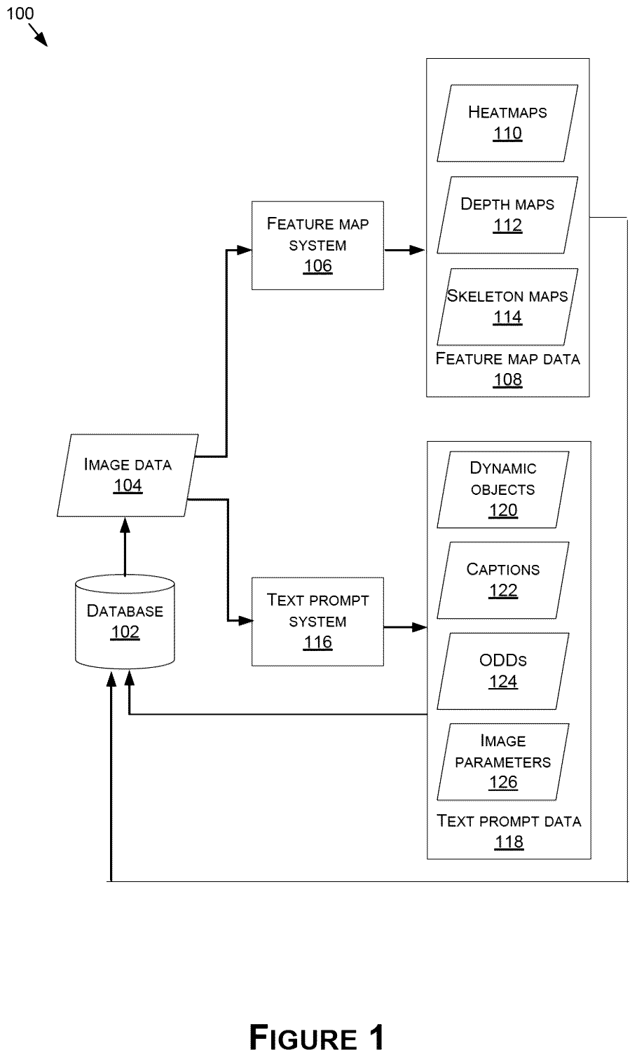

With reference to FIG. 1, FIG. 1 is a block diagram of an example system for preprocessing images, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems implemented using one or more large language models (LLMs), systems implemented using one or more vision language models (VLMs), systems for performing conversational AI operations, systems for performing light transport simulation, systems for performing collaborative content creation for 3D assets, systems implemented at least partially using cloud computing resources, and/or other types of systems.

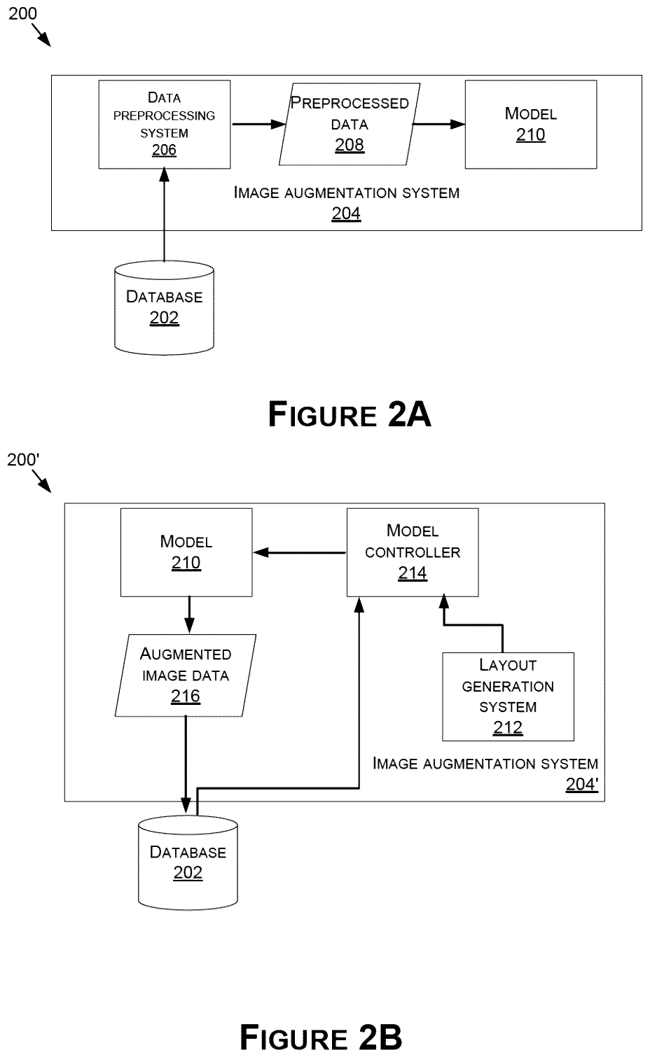

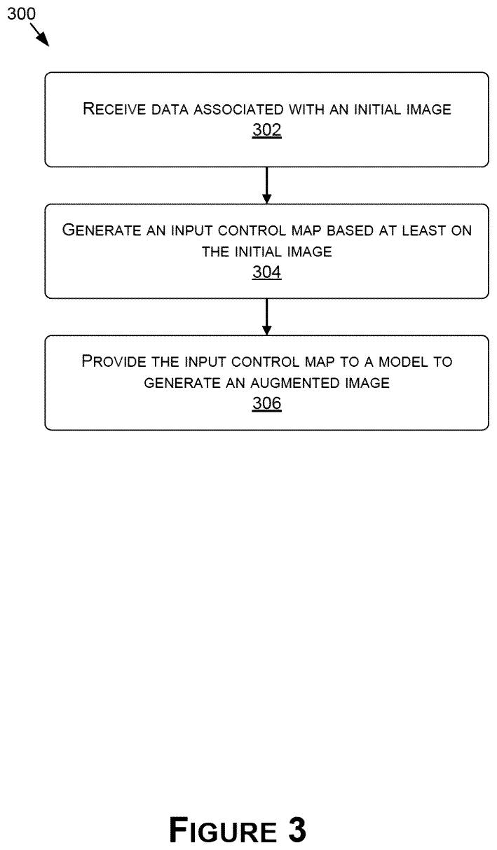

As shown in FIG. 1, illustrated is a block diagram of an example system for preprocessing images. As shown in FIG. 1, a computing environment 100 includes a database 102, feature map system 106, and text prompt system 116. In some implementations, the database 102, feature map system 106, and text prompt system 116 may interconnect (e.g., establish a connection to communicate and/or the like) via wired and/or wireless connections. For example, the database 102, feature map system 106, and/or text prompt system 116 may interconnect to create one or more network environments (described herein) to transmit and/or receive data. In some implementations, the database 102, feature map system 106, and/or text prompt system 116 may transmit and/or receive image data 104, feature map data 108, and text prompt data 118, and/or other data described herein but not explicitly shown. In some implementations, the database 102, feature map system 106, and/or text prompt system 116 may be associated with an entity that is generating and/or updating training data used by perception systems to classify objects, such entities including, for example, automated vehicle developers, entities providing data and/or services to automated vehicle developers, and/or the like. In some implementations, the database 102, feature map system 106, and/or text prompt system 116 may be implemented by one or more systems described herein (e.g., by one or more of image augmentation system 204 of FIG. 2A, image augmentation system 204′ of FIG. 2B, image augmentation systems described with respect to FIG. 3, and/or other systems described herein).

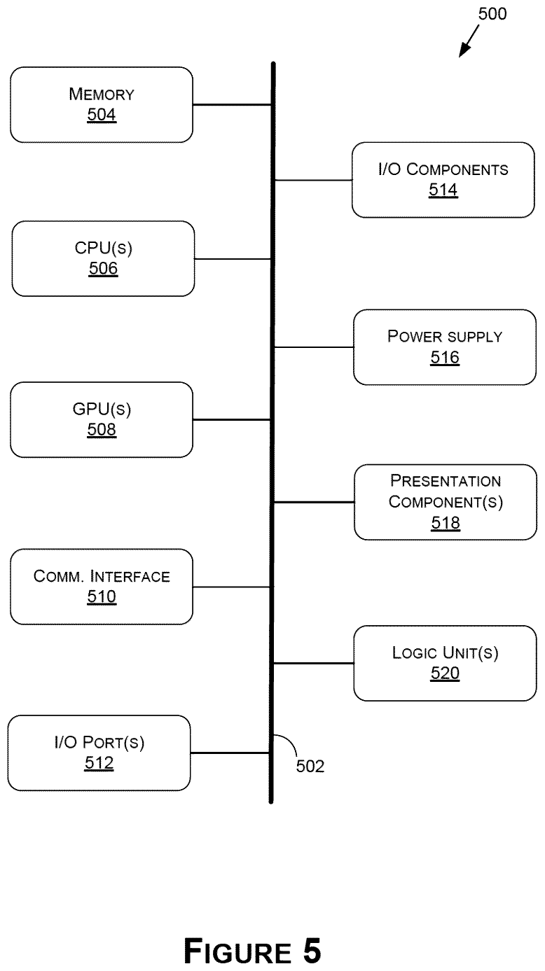

The database 102 may include one or more computing devices (e.g., one or more computing devices that are the same as, or similar to computing device 500 of FIG. 5) in communication with feature map system 106 and/or text prompt system 116. For example, database 102 may include a computing device such as a laptop computer, a desktop computer, a server, a virtual machine, virtual hardware, and/or the like.

The database 102 may obtain (e.g., receive) data associated with, for example, operation of one or more vehicles or other systems with perception (not explicitly shown). For example, the database 102 may receive data associated with operation of one or more autonomous or semi-autonomous vehicles (e.g., vehicles operating at the Society of Automotive Engineers (SAE International) Levels 2-5, described in the “Taxonomy and Definitions for Terms Related to Driving Automation Systems for On-Road Motor Vehicles” (Standard No. J3016-201806). The data associated with the operation of the one or more automated vehicles may be generated during manual, semi-automated, or automated operation of such vehicles. In some implementations, the data associated with the operation of the one or more autonomous or semi-autonomous vehicles includes image data associated with one or more images generated by one or more sensors (e.g., cameras and/or the like) that are supported by (e.g., positioned on and/or integrated into) the autonomous or semi-autonomous vehicles. In some implementations, the database 102 may store the image data associated with the images in memory of the database 102.

In some implementations, the database 102 may provide (e.g., make available for download, transmit, and/or the like) image data 104 to the feature map system 106 and/or the text prompt system 116. For example, the database 102 may transmit the image data 104 associated with the one or more images stored in by the database 102 to the feature map system 106 and/or the text prompt system 116. In example embodiments, the database 102 may identify images stored in the database 102 and generate the image data 104 associated with the one or more images based at least on identifying the images. In some implementations, the database 102 may obtain data corresponding to the one or more images. For example, the database 102 may receive feature map data 108 associated with one feature maps generated by the feature map system 106 and/or text prompt data 118 generated by the text prompt system 116. In these examples, the feature map data 108 and/or the text prompt data 118 may be generated by the feature map system 106 and/or the text prompt system 106, respectively, based at least on the feature map system 106 and/or the text prompt system 116 receiving the image data 104.

The feature map system 106 may include one or more computing devices (e.g., one or more computing devices that are the same as, or similar to, computing device 500 of FIG. 5) in communication with database 102. For example, the feature map system 106 may include a computing device such as a laptop computer, a desktop computer, a server, a virtual machine, virtual hardware, and/or the like.

In some implementations, the feature map system 106 receives (accesses, downloads, or otherwise obtains, etc.) image data 104 from the database 102. For example, the feature map system 106 may receive image data 104 from the database 102 along with a request to generate one or more feature maps. In some implementations, the feature map system 106 generates feature map data 108 based at least on receiving the image data 104. For example, the feature map system 106 may receive the image data 104 from the database 102 and the feature map system 106 may generate one or more feature maps based at least on one or more corresponding images associated with the image data 104. In some implementations, the feature maps may include heatmaps 110, depth maps 112, and/or skeleton maps 114. For example, a feature map may include a heatmap 110, the heatmap 112 being a representation of the likelihood that one or more objects are present at one or more locations within an image. In examples, a feature map may include a depth map 112, the depth map 112 representing distances from the sensor that generated a given image to an object that is in proximity to the sensor and represented in the image. In some examples, a feature map may include a skeleton map 114, the skeleton map 114 representing a pose of an individual that is in proximity to (or within the range of) the sensor and at least partially represented in the image as determined by, for example, a feature map system and/or an image augmentation system, described herein. In some implementations, the feature map system 106 rasterizes the feature maps. For example, the feature map system 106 may rasterize the feature maps by converting the feature maps to a bitmap image format (e.g., PNG, JPG, BMP, and/or the like). The rasterized feature maps may then be used later by image-based systems such as, for example, perception systems implementing one or more neural networks (e.g., convolutional neural networks and/or the like) for purposes of object classification.

The text prompt system 116 may include one or more computing devices (e.g., one or more computing devices that are the same as, or similar to, computing device 500 of FIG. 5) in communication with database 102. For example, the text prompt system 116 may include a computing device such as a laptop computer, a desktop computer, a server, a virtual machine, virtual hardware, and/or the like.

In some implementations, text prompt system 116 receives image data 104 from the database 102. For example, the text prompt system 116 may receive image data 104 from the database 102 along with a request to generate one or more text prompts. In some implementations, the text prompt system 116 generates text prompt data 118 based at least on receiving the image data 104. For example, the text prompt system 116 may receive the image data 104 from the database 102 and the text prompt system 116 may generate one or more text prompts based at least on one or more corresponding images associated with the image data 104. In some implementations, the text prompt includes descriptions of dynamic objects 120 (e.g., strings of text identifying objects captured in a given image that are capable of moving such as vehicles, pedestrians, bicyclists, and/or the like (collectively referred to as “agents”)), captions 122 (e.g., strings of text describing a scenario in a given image), operational design domains (ODDs) 124 (e.g., strings of text describing the conditions under which the vehicle is being operated in a given image (e.g., rainy weather, sunny weather, daytime, nighttime, and/or the like)), and/or image parameters (e.g., strings of text describing sensor configurations such as shutter speed and/or the like). In some implementations, the text prompt system 116 may generate the text prompt(s) based at least on user input (e.g., based at least on human input of the text prompts and/or tags corresponding to objects or scenarios represented in or by the images). In some implementations, a text prompt includes four parts as illustrated in FIG. 1, and in other implementations, may include more than four parts, or fewer than four parts.

In some implementations, the text prompt system 116 uses an object detector (e.g., a YOLOV5-based object detector and/or the like) to detect dynamic objects such as cars, buses, trucks, pedestrians etc. and add them to text prompts if they occur (e.g., “pedestrians, cars, buses on the road”). If no object is detected, the text prompt system 116 uses “on the road.” In some implementations, where an image augmentation system is configured to generate images associated with pedestrians and scooters, the text prompt system 116 may add a second part to the text prompt to describe the objects and/or agents individually. In some implementations, the text prompt system 116 crops an image patch of an initial image where a person is detected and use a model (e.g., a model that is the same as, or similar to, the BLIP-2 model for generating text and image features) to generate a caption corresponding to the image patch and add it to text prompt. For example, the text prompt system 116 may crop the image patch (e.g., a portion of the initial image) that is associated with (e.g., corresponds to) a bounding box placed around a pedestrian represented in the image patch and provide data associated with the image patch to a model. In this example, the data may cause the model to provide as output data associated with a text prompt, the text prompt including a string of text representing the individual (e.g., the pose of the individual, the location of the individual, and/or the like). In some implementations, a text prompt includes ODD information for each image. The ODD information can correspond to text including, as examples, “intersection”, “curvy road”, “slope”, “botts dots”, “lane next to bike lane”, “lane next to parking”, “rural”, “downhill slopes”, “uphill slopes”, “intersection type”, and/or the like. In some implementations, the text prompt system 116 includes information about the road scene and image content. For example, the text prompt system 116 may use a model (e.g., a BLIP2 QA model) to obtain (from the model) weather, illumination and day/night information for each image and add the information to the text prompt. The text prompt system 116 may then include (e.g., append) text representing the weather, illumination, and day/night information (e.g., “raining”, “sunny”, “foggy”, and/or the like) in the text prompt.

With continued reference to FIG. 1, the database 102 may receive (or otherwise obtain) the feature map data 108 and/or the text prompt data 118 from the feature map system 106 and/or the text prompt system 116, respectively. In some implementations, the database 102 may store the feature map data 108 and/or the text prompt data 118 in association with the image data 104 used to generate the feature map data 108 and/or the text prompt data 118. For example, the database 102 may update the image data 104 to include the corresponding feature map data 108 and/or text prompt data 118. In examples, the database 102 may update the image data 104 by adding another instance of the image data 104 (not expressly shown) in association with the feature map data 108 and/or the text prompt data 118 separate from the originally-input image data 104. In some implementations, the database 102 may provide the image data 104 continuously (e.g., immediately in response to receiving the image data 104, as image data 104 is received) or periodically (e.g., at predetermined time intervals, if image data 104 has been received during a previous time interval).

With reference to FIGS. 2A and 2B, FIGS. 2A and 2B illustrate an example computing environment 200 for training models, and an example computing environment 200′ for deploying models in accordance with embodiments of the present disclosure. In some implementations, computing environment 200 and computing environment 200′ may share one or more components not explicitly reproduced across FIGS. 2A and 2B.

As shown in FIG. 2A, computing environment 200 includes a database 202 (which may be the same as, or similar to, database 102 of FIG. 1), image augmentation system 204, data preprocessing system 206, and/or model 210. In some implementations, the database 202 and the image augmentation system 204 may interconnect (e.g., establish a connection to communicate and/or the like) via wired and/or wireless connections. For example, the database 202 and the image augmentation system 204 may interconnect to create one or more network environments (described herein) to transmit and/or receive data. In some implementations, the database 202 and image augmentation system 204 may transmit and/or receive image data (e.g., image data that is the same as, or similar to image data 104 of FIG. 1) and/or other data described herein but not explicitly shown. In some implementations, the database 202 and/or the image augmentation system 204 may be associated with an entity that is generating and/or updating training data used by perception systems to classify objects, such entities including, for example, automated vehicle developers, entities providing data and/or services to automated vehicle developers, and/or the like.

As shown in FIG. 2B, the computing environment 200 includes database 200 and image augmentation system 204′ (which may be the same as, or similar to, image augmentation system 204, described above). In some implementations, the database 202 and the image augmentation system 204′ interconnect (e.g., establish a connection to communicate and/or the like) via wired and/or wireless connections. For example, the database 202 and the image augmentation system 204′ may interconnect to create one or more network environments (described herein) to transmit and/or receive data. In some implementations, the database 202 and the image augmentation system 204′ may transmit and/or receive image data (e.g., image data that is the same as, or similar to image data 104 of FIG. 1), augmented image data 216, and/or other data described herein but not explicitly shown.

### Model Training

Referring now to FIG. 2A, the database 202 may include one or more computing devices (e.g., one or more computing devices that are the same as, or similar to computing device 500 of FIG. 5) in communication with the image augmentation system 204. For example, the database 202 may include a computing device such as a laptop computer, a desktop computer, a server, a virtual machine, virtual hardware, and/or the like.

The image augmentation system 204 may include one or more computing devices (e.g., one or more computing devices that are the same as, or similar to computing device 500 of FIG. 5) in communication with the database 202. For example, the image augmentation system 204 may include a computing device such as a laptop computer, a desktop computer, a server, a virtual machine, virtual hardware, and/or the like. In some implementations, the image augmentation system 204 includes data preprocessing system 206 and/or model 210. For example, the image augmentation system 204 may include data preprocessing system 206 and/or model 210, where the data preprocessing system 206 and/or model 210 include one or more separate computing devices (e.g., the same or similar to computing device 500). Additionally, or alternatively, the data preprocessing system 206 and/or model 210 may be implemented by the image augmentation system 204 as program modules.

In some implementations, the database 202 provides image data associated with one or more images to the image augmentation system 204. For example, the database 202 may provide the image data associated with the one or more images to the data preprocessing system 206. In some implementations, the one or more images may be associated with labels. The images may represent a diverse, large scale, and scalable set of ground-truth images and labels. The labels may correspond to classifications of one or more objects represented in the images as vehicles, being pedestrians, bicyclists, generic objects, static and/or dynamic road features, and/or the like. The classifications may correspond to the classifications that one or more models implemented by perception systems (not explicitly shown) are trained and/or updated to generate based at least on images generated by a vehicle during operation. In some implementations, the images are associated with a text prompt. For example, the images may be associated with a text prompt (e.g., a text prompt that is the same as, or similar to, the text prompts described in FIG. 1) that includes descriptions of one or more aspects of the respective images. In some implementations, the text prompt includes descriptions of objects in the images, the operational design domains represented by the images, the pedestrians represented by the images, the weather and/or illumination conditions represented by the images and/or the like. In some implementations, the image augmentation system 204 may cause the data preprocessing system 206 to generate preprocessed data 208, where the preprocessed data 208 is associated with the images, their corresponding labels, and their corresponding text prompts. Some illustrative examples of text prompts include (without limitation): Example 1: “3 cars on the road. Complete intersection. A man in orange jacket is walking.” Example 2: “1 car, 1 truck, 1 bus on the road.” Example 3: “On the road.”

In some implementations, the image augmentation system 204 may train and/or update the model 210. In some implementations, where the model 210 includes a first network (e.g., a hyper network) and a second network (e.g., a diffusion network, a stable diffusion network (sometimes referred to as a stable diffusion model), and/or the like), the image augmentation system 204 may train and/or update the first network, where the first network includes a clone (e.g., a copy) of at least a portion of the second network. For example, where the second network is a fully-trained stable diffusion network that takes as input a string of text and an image (e.g., a noisy image) and provides as its output an image corresponding to the string of text, the first network may include a clone of one or more of the encoder layers of the fully-trained diffusion network. In this example, the image augmentation system 204 may forgo training and/or updating the fully-trained stable diffusion network. For a detailed description of the use of neural network architectures to add spatial conditioning controls to large, pretrained text-to-image diffusion models, reference may be made to Zhang et al., Adding Conditional Control to Text-to-Image Diffusion Models, arXiv: 2302.05543 (Nov. 26, 2023), https://arxiv.org/abs/2302.05543, the entire contents of which are hereby incorporated by reference in their entirety.

For example, the image augmentation system 204 may train and/or update the model 210 based at least on the preprocessed data 208. In some implementations, the image augmentation system 204 may train and/or update the first network by providing an input control map (e.g., an input control map that is the same as, or similar to, the input control map described with respect to FIG. 3) and corresponding text prompt to the first network to cause the first network to provide a series of outputs (first network tensors). The image augmentation system 204 may generate the input control map based at least on the preprocessed data 208 (e.g., based at least on images associated with the preprocessed data). In addition, the image augmentation system 204 may provide the text prompt and an image (e.g., the image associated with the preprocessed data 208, a noisy image and/or other images) to the second network. As the second network generates a series of outputs (e.g., second network tensors) the image augmentation system 204 may combine at least some of the tensors generated by the first network with corresponding tensors generated by the second network to cause the second network to generate an output. The output may include data associated with an augmented image. In some implementations, the image augmentation system 204 may then update one or more weights of the first network based at least on a comparison of the augmented image with the image represented by the preprocessed data 208 corresponding to the input control map, while simultaneously forgoing updating the weights of the second network. In this way, the image augmentation system 204 can forgo the significant expenditure of computing resources needed to train the second network while at least partially training the first network, which can take orders of magnitude more time to train when compared to the training of the first network. In some implementations, the image augmentation system 204 may then similarly train and/or update one or more weights of both the first network and the second network based at least on (e.g., after) the image augmentation system 204 trains and/or updates the first network while forgoing training and/or updating of the second network. In some implementations, the first network and/or the second network may be associated with a variational autoencoder and/or latent diffusion model(s).

### Image Augmentation

Referring now to FIG. 2B, the image augmentation system 204′ may be the same as, or similar to, the image augmentation system 204 and in communication with the database 202. In some implementations, the image augmentation system 204′ includes a layout generation system 212, model controller 214, and/or the model 210. For example, the image augmentation system 204′ may include the layout generation system 212, model controller 214, and/or model 210, where the layout generation system 212, model controller 214, and/or model 210 include one or more separate computing devices (e.g., the same or similar to computing device 500). Additionally, or alternatively, the layout generation system 212, model controller 214, and/or model 210 may be implemented by the image augmentation system 204′ as program modules.

In some implementations, the database 202 provides data associated with an initial image to the image augmentation system 204′ to cause the image augmentation system 204′ to provide augmented image data 216. The data associated with the initial image may be the same as, or similar to, images associated with preprocessed data 208 and/or may be different images. In some implementations, the images include a set of images corresponding to a point in time. For example, the images may be captured by a plurality of sensors supported by (e.g., installed in and/or on) a vehicle. In some implementations, the database 202 provides the data associated with the initial image to the model controller 214 of the image augmentation system 204′. In some implementations, the image data 216 associated with the initial image includes feature map data (e.g., feature map data that is the same as, or similar to, feature map data 108 of FIG. 1) and/or text prompt data (e.g., text prompt data that is the same as, or similar to, text prompt data 118 of FIG. 1).

In some implementations, the image augmentation system 204′ causes the layout generation system 212 to provide layout data associated with a layout to the model controller 214. The layout may represent one or more features of an environment represented in the initial image to include and/or update when generating the augmented image data 216. Additionally, or alternatively, the layout may represent one or more features of an environment to add or update. In some implementations, the layout data is based at least on input received by the image augmentation system 204′. For example, one or more users and/or one or more other systems (such as simulation systems involved in generating images for autonomous or semi-autonomous vehicle testing, training and/or updating perception systems, and/or the like that are not explicitly shown) may provide input via one or more input devices and/or interfaces to the layout generation system 212. The input may represent the features to include and/or update when generating the augmented image data 216 for the initial image and/or a set of initial images (e.g., some or all of the images stored in the database 202). In some implementations, the input provided by the users and/or one or more other systems may indicate that one or more images need to be augmented to include one or more features that are not represented in, or not sufficiently represented in, the images stored by the database 202. The representation of one or more objects and/or agents in a set of images stored in the database 202 may be deemed to be insufficient where the number of images representing such objects and/or agents is at or below a threshold number and/or at or below a threshold percentage. As a result, training and/or updating a perception system based at least on (e.g., using) the images stored in the database 202 may not enable the perception system to classify such objects and/or agents when encountered during testing and/or in real-world use.

In some implementations, the layout generation system 212 generates and/or receives one or more input control maps (e.g., input control maps that are the same as, or similar to, the input control map described with respect to FIG. 3). For example, the layout generation system 212 may generate and/or receive the one or more input control maps based at least on one or more initial images provided to the image augmentation system 204′ by the database 202. Additionally, or alternatively, the image augmentation system 204′ may determine the input control map based at least on the layout and one or more predetermined input control maps. For example, the image augmentation system 204′ may generate one or more input control maps when generating preprocessed data (e.g., preprocessed data that is the same as, or similar to, preprocessed data 208).

In some implementations, the layout generation system 212 determines an input control map based at least on the input provided via the one or more input devices and/or the interfaces to the layout generation system 212. For example, the layout generation system 212 may determine one or more input control maps corresponding to the input provided and the layout generation system 212 may provide the one or more input control maps to the model controller 214. As an illustrative example, where the input provided is associated with (e.g., indicates) a need for augmented images including more pedestrians, the layout generation system 212 may identify an input control map in which one or more pedestrians can be included (e.g., where one or more drivable or non-drivable surfaces represented by the image associated with a given input control map include areas where pedestrians can be located such as cross-walks, sidewalks, streets, and/or the like). In this example, the layout generation system 212 may generate the input control map based at least on preprocessed data associated with the associated with a given initial image.

In some implementations, the model controller 214 receives data associated with the input provided via the one or more input device and/or the interfaces (described above). For example, the model controller 214 may receive the data associated with the input from the image augmentation system 204′. Additionally, or alternatively, the model controller 214 may receive the data associated with the input from the layout generation system 212. As noted above, the input may represent the features to include and/or update when generating the augmented image data 216. For example, where a user determines that additional images are needed that have an increased representation of pedestrians, the user may provide input to the model controller 214 indicating that the additional images are needed with such an increased representation. Additionally or alternatively, one or more systems involved in training and/or updating perception systems described herein may determine that a given perception system is classifying objects or agents with a degree of accuracy that is lower than an acceptable degree of accuracy (e.g., lower than 99% accuracy, lower than 95% accuracy, or lower than 90% accuracy). In this case, the one or more systems may generate the input indicating that images with an increased representation of pedestrians is needed for training and/or updating the perception systems (e.g., the models associated with the perception systems). In some implementations, the input may include a text input representing a text prompt (e.g., one or more strings of text). For example, where an increased representation of pedestrians is needed/beneficial, a text input representing a text prompt “a car driving down the road with pedestrians around the car” may be provided.

In some implementations, the model controller 214 provides the input control map and/or the text input to the model 210 to cause the model 210 to generate augmented image data 216. For example, the model controller 214 may provide the data as inputs to the model 210, to cause the model 210 to generate the augmented image data 216. This generation may occur in response to receiving the input, the input control map, and/or the text prompt. In some implementations, the model controller 214 may forgo providing either the input control map or the text input to the model 210 when causing the model 210 to generate the augmented image data. In some implementations, the augmented image data 216 is associated with an augmented image. In example embodiments, the augmented image may correspond to an initial image (described above).

In some implementations, the image augmentation system 204′ provides the augmented image data 216 to the database 202. For example, the image augmentation system 204′ may provide the augmented image data to the database 202 based at least on receiving the data associated with the initial image from the database 202 and the image augmentation system 204′ causing the model 210 to generate the augmented image data 216. In some implementations, the image augmentation system 204′ provides the augmented image data 216 in association with the initial image that the image augmentation system 204′ used when generating the augmented image represented by the augmented image data 216.

It should be understood that this and other arrangements described herein are set forth only as examples. Other arrangements and elements (e.g., machines, interfaces, functions, orders, groupings of functions, etc.) may be used in addition to or instead of those shown in FIGS. 1-2B, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Now referring to FIG. 3, each block of method 300, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), as or through an application programming interface (API), or a plug-in to another product, to name a few. In addition, method 300 is described, by way of example, with respect to the systems of FIGS. 1-2B. However, this method may additionally or alternatively be executed by any one system, or any combination of systems, including, but not limited to, those described herein.

FIG. 3 is a flow diagram showing a method 300 for generating synthetic data from images and text for automated vehicle systems and applications, in accordance with some embodiments of the present disclosure. The method 300 may be implemented by one or more systems, devices, or components discussed above.

The method 300, at block 302, includes receiving data associated with an initial image. For example, an image augmentation system (e.g., an image augmentation system that is the same as, or similar to, image augmentation system 204 and/or image augmentation system 204′ of FIGS. 2A and 2B) may receive data associated with an initial image. In some implementations, the data associated with the initial image may include preprocessed data (e.g., preprocessed data that is the same as, or similar to, the preprocessed data 208 of FIG. 2A). In some implementations, the image augmentation system may receive the data associated with the initial image from a database (e.g., a database that is the same as, or similar to, the database 102 and/or the database 202 of FIGS. 1, 2A, and 2B). For example, the image augmentation system may receive the data associated with the initial image, where the initial image depicts (e.g., represents) an environment of a vehicle during operation. In some implementations, the image augmentation system may receive the data associated with the initial image, where the initial image includes a plurality of images representing at least partially different fields of view of the vehicle during operation at points in time.

In some implementations, the image augmentation system may determine one or more labels and/or one or more bounding boxes for the initial image. For example, the image augmentation system may provide the initial image to a perception system that is configured to classify objects and/or regions of images. The perception system may then provide the one or more labels and/or the one or more bounding boxes based at least on the initial image. In this example, the image augmentation system may then associate the one or more labels and/or the one or more bounding boxes with the initial image. In some implementations, the one or more labels may be associated with (e.g., correspond to) the one or more bounding boxes.

In some implementations, the image augmentation system may determine one or more labels and/or one or more bounding boxes associated with one or more image features to augment in the initial image. For example, the image augmentation system may receive input via one or more input devices and/or interfaces that represent the features to augment (e.g., include and/or update) in the initial image. The image augmentation system may then determine one or more associations between the feature to augment, and the one or more labels and/or one or more bounding boxes. In some implementations, the image augmentation system may determine a text prompt based at least on the one or more labels and/or the one or more bounding boxes that are associated with the image features to augment in the initial image. In some implementations, the image augmentation system may determine the text prompt based at least on a (e.g., one or more) language model, such as a large language model (LLM) or a vision language model (VLM). For example, the image augmentation system may select a text prompt and then provide the text prompt as input to an LLM to cause the LLM to provide an updated text prompt. The image augmentation system may then use the updated text prompt as an input to one or more models described herein.

The method 300, at block 304, includes generating an input control map based at least on the initial image (e.g., based at least on the data associated with the initial image). For example, the image augmentation system may generate the input control map (sometimes referred to as a feature map). In some implementations, the image augmentation system may receive data associated with user input from a first user that is similar to the input received via one or more input devices and/or interfaces that represent the features to augment. In some implementations, the input may represent an image mask (e.g., a region or set of regions in an image). For example, the user may highlight certain regions or sets of regions in the initial image when providing input that is received by the image augmentation system. Additionally, or alternatively, the input may be provided by a system (e.g., a perception system capable of classifying regions of images as, for example, drivable surfaces, non-drivable surfaces, and/or the like). In these examples, the image augmentation system may generate the input control map based at least on the image mask and/or the initial image.

In some implementations, the image augmentation system may determine one or more splines associated with the initial image. For example, the image augmentation system may determine one or more splines based at least on the image augmentation system identifying one or more edges in the images and fitting one or more splines to the one or more edges. In some implementations, the image augmentation system may associate one or more tags with one or more splines. For example, the image augmentation system may determine that a spline corresponds to a feature in the image (e.g., a road edge, a traffic sign pole, a pedestrian, a bicyclist, and/or the like) and the image augmentation system may associate a tag (e.g., with each pixel corresponding to the spline) indicating the feature in the image that corresponds to the spline. In some implementations, the image augmentation system may generate an input control map based at least on the one or more splines. For example, the image augmentation system may include the one or more splines in the input control map before providing the input control map to a neural network model (e.g., a neural network model that is the same as, or similar to, neural network model 210 of FIGS. 2A and 2B and/or other similar neural network models).

In some implementations, the image augmentation system may determine one or more edges associated with the initial image. For example, the image augmentation system may determine one or more edges based at least on the image augmentation system identifying one or more edges associated with the initial image using an edge detection algorithm (e.g., a Canny edge detection algorithm and/or the like). In some implementations, the image augmentation system may generate the input control map based at least on the one or more edges associated with the initial image. For example, the image augmentation system may include the one or more edges in the input control map. In this example, the image augmentation system may determine that the edges (e.g., the individual pixels or groups of pixels that are identified as edges) correspond to a feature in the image (as discussed above) and the image augmentation system may associate a tag with the edges representing the feature(s) in the image corresponding to the edges. In some implementations, the image augmentation system may include the one or more edges in the input control map before providing the input control map to a model (e.g., a model that is the same as, or similar to, model 210 of FIGS. 2A and 2B and/or other similar models).

In some implementations, the image augmentation system may determine one or more image masks associated with the initial image. For example, the image augmentation system may determine one or more image masks based at least on the image augmentation system identifying one or more image masks associated with the initial image using techniques such as thresholding and/or the like. Examples of thresholding include distinguishing between pixels in an image based on the pixels' color values, intensity values, and/or differences in color or intensity values when compared to other pixels (e.g., adjacent pixels, average pixels in a portion or all of an image, and/or the like). In some implementations, the image augmentation system may generate the input control map based at least on the one or more image masks associated with the initial image. For example, the image augmentation system may include the one or more image masks in the input control map. In this example, the image augmentation system may determine that the image masks (e.g., the individual pixels or groups of pixels that are identified as included in an image mask) correspond to a feature in the image (as discussed above) and the image augmentation system may associate a tag with the image masks representing the feature(s) in the image corresponding to the image masks. In some implementations, the image augmentation system determines the one or more image masks based at least on input (described above). In some implementations, the image augmentation system may include the one or more image masks in the input control map before providing the input control map to a model (e.g., a model that is the same as, or similar to, model 210 of FIGS. 2A and 2B and/or other similar models).

In some implementations, the image augmentation system may determine one or more segmentation masks associated with the initial image. For example, the image augmentation system may determine one or more segmentation masks based at least on the image augmentation system identifying one or more segmentation masks associated with the initial image using one or more models (not explicitly illustrated) trained to segment portions of images. In some implementations, the image augmentation system may generate the input control map based at least on the one or more segmentation masks associated with the initial image. For example, the image augmentation system may include the one or more segmentation masks in the input control map. In this example, the image augmentation system may determine that the segmentation masks (e.g., the individual pixels or groups of pixels that are identified as included in a segmentation masks) correspond to a feature in the image (as discussed above) and the image augmentation system may associate a tag with the segmentation masks representing the feature(s) in the image corresponding to the segmentation masks. In some implementations, the image augmentation system may include the one or more segmentation masks in the input control map before providing the input control map to a model (e.g., a model that is the same as, or similar to, model 210 of FIGS. 2A and 2B and/or other similar models).

The method 300, at block 306, includes providing the input control map to a model to generate an augmented image. For example, an image augmentation system may provide the input control map to a model (e.g., a model that is the same as, or similar to, model 210 of FIGS. 2A and 2B) to cause the model to generate an output. In some implementations, the image augmentation system may provide the input control map to the model to cause the model to generate, as an output, data associated with an augmented image.

In some implementations, image augmentation system may associate an input control map with a text input and the image augmentation system may provide the input control map and the text input to the model based at least on their association. For example, the image augmentation system may select a text input based at least on the image augmentation system selecting a text prompt from among a plurality of text prompts. In this example, the image augmentation system may associate the text input corresponding to the selected text prompt with the input control map. In some implementations, the text prompt may be associated with one or more image features to include and/or update when generating an augmented image. For example, the text prompt may be associated with one or more features that are different from one or more features included in the initial image. In this example, the one or more feature associated with the text prompt may cause the image augmentation system to update and/or remove the one or more feature included in the initial image. In examples, the text prompt may be associated with one or more features that are not included (e.g., that are to be added) in the initial image. The image augmentation system may then provide the input control map and associated text input to the model to cause the model to generate an output.

In some implementations, the image augmentation system may select a text prompt based at least on one or more segmentation masks when associating the corresponding text input with an input control map. For example, the image augmentation system may determine one or more image segmentation masks associated with the initial image (discussed above) and the image augmentation system may select the text prompt based at least on image segmentation masks associated with the initial image. In examples, the image augmentation system may determine that one or more image segmentation masks corresponding to drivable surfaces further corresponds to one or more text prompts associated with drivable surfaces. The image augmentation system may then select the text prompt based at least on this correspondence between the image segmentation mask and the text prompts and associate the corresponding text input with the input control map for the initial image.

In some implementations, when providing the input control map and/or the text input to the model, the image augmentation system provides the input control map and/or the text input to a generative model. For example, the image augmentation system may provide the input control map and/or the text input to a stable diffusion model. In some implementations, the image augmentation system may provide the input control map and/or the text input to a model, where the model includes a first network (e.g., a hyper network) and a second network. For example, the image augmentation system may provide the input control map and the text input to the first network and the image augmentation system may also provide the text input and an image (e.g., a noisy image, a predetermined image, the initial image, and/or the like) to the second network. The first network may be associated with (e.g., connected to) the second network as discussed with respect to model 210 of FIGS. 2A and 2B) and providing the input control map, text input, and image may cause the model (e.g., the first network of the model) to provide outputs (e.g., tensors) via the first network to the second network (e.g., combined with corresponding tensors of the second network) to control generation of the augmented image by the model (e.g., by the second network).

In some implementations, generation of the augmented image may be based on augmenting one or more static objects (e.g., static road features such as lane lines, road boundaries, poles, signs, traffic signals, regions of interest, and/or stop lines) and/or one or more dynamic objects (e.g., objects and agents such as traffic cones, pedestrians, bicyclists, and/or the like) that are represented by the input control map and/or the text input to the model. For example, the image augmentation system may provide the input control map and/or the text input to the model to cause the model to generate the output. The output may include an augmented image which, in comparison to the initial image, includes, excludes, and/or changes certain objects or agents identified by the prompt. In the case of static objects, the static objects may remain the same (e.g., static road features may be reproduced such that they are represented the same as, or similar to, how they were represented in the original image) or may be augmented (e.g., excluded, moved, changed in color, changed in texture, and/or the like). In the case of dynamic objects, the dynamic objects may likewise remain the same or be augmented. In some implementations, the image augmentation system may then compare the initial image with the augmented image and determine the one or more changes to the static objects and/or the dynamic objects. For example, the image augmentation system may compare the initial image with the augmented image and determine that one or more static features (e.g., road lane lines) are present, unchanged, and/or changed in both. The image augmentation system may then further associate a tag with the static features (e.g., by associating a tag with each pixel corresponding to the static features in the augmented image), the tag identifying the static feature (e.g., as a road lane line). Additionally, or alternatively, the image augmentation system may compare the initial image with the augmented image and determine that one or more dynamic features are present, unchanged, and/or changed in both the initial image and the augmented image. The image augmentation system may similarly further associate a tag with the dynamic objects. In this way, the augmented images may later be used when training, for example, models associated with perception systems (e.g., perception systems involved in classifying one or more objects and/or agents during automated vehicle operation) based on the augmented images and the corresponding tags associated with such images.

In some implementations, the image augmentation system updates a dataset (e.g., an initial dataset) based at least on the image augmentation system generating the augmented image. For example, where image augmentation system receives data associated with an initial image from a database, the database may contain one or more images (including the initial image) that are stored as an initial dataset. In this example, the image augmentation system may update the initial dataset by updating the data associated with the initial dataset. In some implementations, the image augmentation system may provide augmented image data (e.g., that is the same as, or similar to, the augmented image data described with respect to FIG. 2B) to the database to cause the database to include and/or replace the augmented image data with the data associated with the initial image.

Additionally, or alternatively, the image augmentation system may generate a second dataset based at least on the data associated with the augmented image. For example, the image augmentation system may receive one or more initial images and the image augmentation system may generate one or more corresponding augmented images. In this example, the image augmentation system may store data associated with the one or more augmented images in a second dataset (e.g., a dataset that is separate from the initial dataset). In some implementations, the image augmentation system may then provide the data associated with the one or more augmented images to the database. In some implementations, the image augmentation system may determine a correspondence between the initial image and the augmented image. For example, the image augmentation system may associate identifiers for both the initial image and the augmented image and can determine the correspondence based at least on (e.g., during and/or after) generating the augmented image. In some implementations, the image augmentation system may generate the second dataset based at least on the augmented image and the correspondence between the initial image and the augmented image. In some implementations, the image augmentation system includes both the data associated with the initial image and the data associated with the corresponding augmented image in the second dataset.

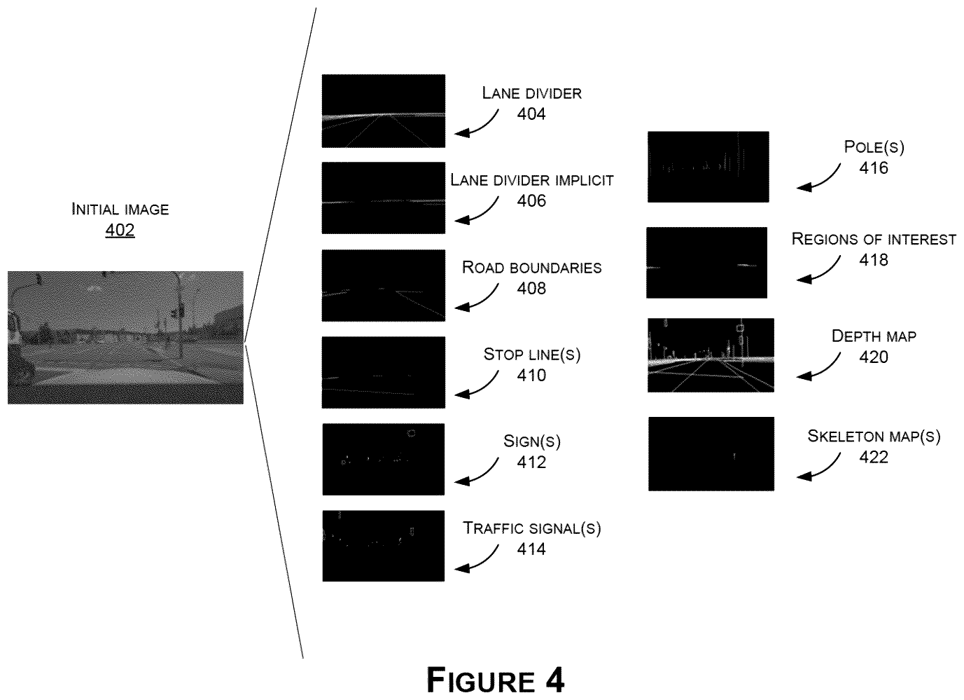

FIG. 4 is a diagram of an example initial image and corresponding feature maps. As shown in FIG. 4, an initial image 402 corresponds with multiple feature maps. The example feature maps may be determined by a feature map system (e.g., feature map system 106) and/or an image augmentation system (e.g., image augmentation system 204, 204′, and/or the image augmentation system described with respect to FIG. 3). In some implementations, the example feature maps may be used by the above-noted systems to generate image data as described herein.

The example feature maps include a lane divider map 404, a lane divider implicit map 406, a road boundary map 408, a stop line map 410, a sign map 412, a traffic signal map 414, a pole map 416, a region of interest map 418, a depth map 420, and a skeleton map 422. The lane divider map may represent one or more lane dividers represented in one or more initial images. The lane divider implicit map 406 may represent one or more lane dividers that are not physically represented via markings on the road. The road boundary map 408 may represent one or more road boundaries that may or may not be physically represented via markings on the road. The stop line map 410 may represent one or more stop lines (e.g., intersection boundaries and/or the like) that may or may not be physically represented via markings on the road. The sign map 412 may represent one or more road signs (e.g., one or more edges of the one or more road signs) in the environment. The traffic signal map 414 may represent one or more traffic signals (e.g., one or more edges of the one or more traffic signals) in the environment, a pole map 416 may represent one or more poles (e.g., one or more edges of the one or more poles such as light poles) in the environment. The region of interest map 418 may represent one or more regions of interest (e.g., one or more boundaries defining areas within an environment where individual drivers and/or driving automation systems need to direct special attention when operating vehicles) in the environment. Regions of interest can include, for example, areas where vehicle and pedestrians are permitted be (e.g., crosswalks, pick-up and drop-off (PuDo) areas, and/or the like). The depth map 420 may represent a plurality of distances between a given sensor and points along surfaces of objects or agents in the environment. The skeleton map 422 may represent one or more poses of one or more individuals (pedestrians and/or the like) in the environment.

It will be understood that the feature maps described herein are provided for illustrative purposes only and that other feature maps may be used in addition to, or in place of, the feature maps identified herein.

### Example Computing Device

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof. As noted throughout the description of FIGS. 1-2B, one or more computing devices described herein (e.g., databases, feature map systems, text prompt systems, image augmentation systems, and/or other related components of each of these systems) may include one or more components that are the same as, or similar to, one or more components described with respect to FIG. 5.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that enable the computing device 500 to communicate with other computing devices via an electronic communication network, included wired and/or wireless communications. The communication interface 510 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may enable the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that enable detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to enable the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### Example Data Center

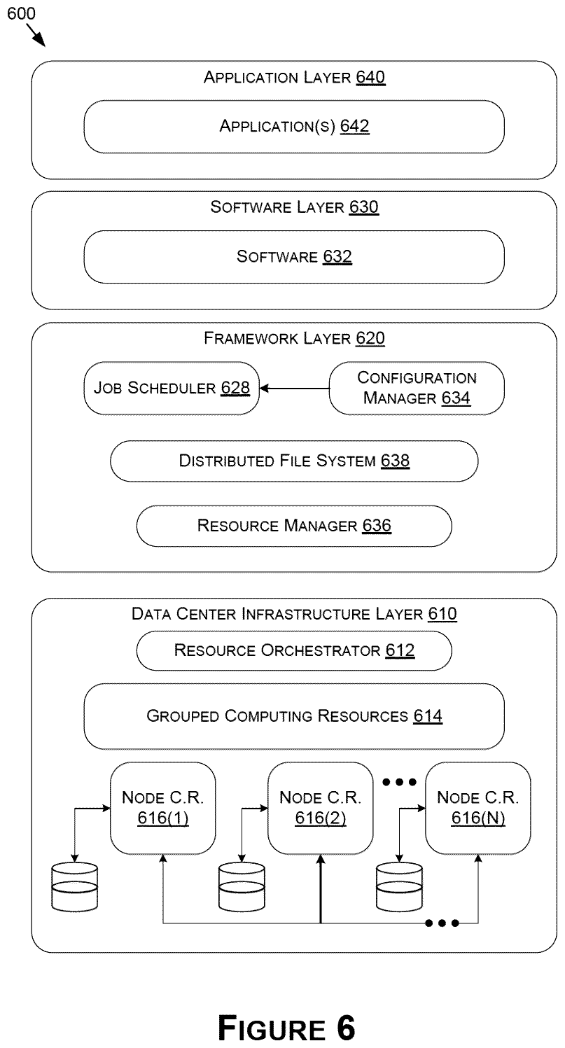

FIG. 6 illustrates an example data center 600 that may be used in at least one embodiments of the present disclosure. The data center 600 may include a data center infrastructure layer 610, a framework layer 620, a software layer 630, and/or an application layer 640. In some implementations, one or more computing devices described herein (e.g., databases, feature map systems, text prompt systems, image augmentation systems, and/or other related components of each of these systems) may include one or more components that are the same as, or similar to, one or more components described with respect to FIG. 6.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may utilize distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A processor comprising:
one or more circuits to:
obtain data associated with an initial image, the initial image depicting a first set of one or more image features and representing an environment;
generate an input control map based at least on the initial image; and
provide the input control map and a text input to a neural network to cause the neural network to generate an augmented image that includes a second set of one or more image features,
wherein the text input represents a text prompt associated with the second set of one or more image features, the second set of one or more image features being different from the first set of one or more image features.

2. The processor of claim 1, wherein the one or more circuits are to:
update an initial dataset based at least on data associated with the augmented image, the initial dataset comprising the data associated with the initial image.

3. The processor of claim 1, wherein the one or more circuits are to:
generate a second dataset based at least on data associated with the augmented image.

4. The processor of claim 1, wherein the one or more circuits are to:
determine one or more labels and one or more bounding boxes associated with the first set of one or more image features to augment in the initial image, the one or more labels corresponding to the one or more bounding boxes; and
determine the text prompt based at least on the one or more labels and one or more bounding boxes associated with the first set of one or more image features to augment in the initial image.

5. The processor of claim 1, wherein, when generating the input control map, the one or more circuits are to:
determine one or more splines associated with the initial image; and
generate the input control map based at least on the one or more splines associated with the initial image.

6. The processor of claim 1, wherein, when generating the input control map, the one or more circuits are to:
determine one or more edges associated with the initial image; and
generate the input control map based at least on the one or more edges associated with the initial image.

7. The processor of claim 1, wherein, when generating the input control map, the one or more circuits are to:
determine one or more image masks associated with the initial image; and
generate the input control map based at least on the one or more image masks associated with the initial image.

8. The processor of claim 1, wherein, when generating the input control map, the one or more circuits are to:
determine one or more segmentation masks associated with the initial image; and
generate the input control map based at least on the one or more segmentation masks associated with the initial image,
wherein the segmentation masks are associated with an object type in an environment.

9. The processor of claim 3, wherein, when generating the second dataset, the one or more circuits are to:
determine a correspondence between the initial image and the augmented image; and
generate the second dataset based at least on the augmented image and the correspondence between the initial image and the augmented image.

10. The processor of claim 1, wherein the one or more circuits are to:
receive data associated with user input from a user, the user input representing an image mask; and
generate the input control map based at least on the image mask and the initial image.

11. The processor of claim 1, wherein the one or more circuits are to:
select the text prompt from among a plurality of text prompts.

12. The processor of claim 11, wherein the one or more circuits are to:
select the text prompt from among the plurality of prompts based at least on one or more segmentation masks associated with the initial image.

13. The processor of claim 1, wherein the neural network is a stable diffusion model, and
wherein, when providing the input to the stable diffusion model, the one or more circuits are to:
cause the stable diffusion model to provide as output the augmented image based at least on the input control map and the text prompt.

14. The processor of claim 1, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system implemented using one or more large language models (LLMs);
a system implemented using one or more vision language models (VLMs);
a system for performing conversational AI operations;
a system for generating synthetic data;
a system incorporating one or more virtual machines (VMs);
a system implemented at least partially in a data center; or
a system implemented at least partially using cloud computing resources.

15. A system comprising:
one or more processing units to perform operations comprising:
obtaining data associated with an initial image, the initial image depicting a first set of one or more image features and representing an environment;
generating an input control map based at least on the initial image; and
providing the input control map and a text input to a neural network to cause the neural network to generate an augmented image depicting a second set of one or more image features,
wherein the text input represents a text prompt associated with the second set of one or more image features, the second set of one or more image features being different from the first set of one or more image features.

16. The system of claim 15, wherein the one or more processing units perform the operation of:
updating an initial dataset based at least on data associated with the augmented image, the initial dataset comprising the data associated with the initial image.

17. The system of claim 15, wherein the one or more processing units perform the operation of:
generating a second dataset based at least on data associated with the augmented image.

18. The system of claim 15, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system implemented using one or more large language models (LLMs);
a system implemented using one or more vision language models (VLMs);
a system for generating synthetic data;
a system incorporating one or more virtual machines (VMs);
a system implemented at least partially in a data center; or
a system implemented at least partially using cloud computing resources.

19. A method comprising:
receiving, using one or more processing units of a machine, data associated with an initial image, the initial image depicting a first set of one or more image features and representing an environment;
generating, using the one or more processing units of the machine, an input control map based at least on the initial image; and
providing, using the one or more processing units of the machine, the input control map and a text input to a model to cause the model to generate an augmented image depicting a second set of one or more image features,
wherein the text input represents a text prompt associated with the second set of one or more image features, the second set of one or more image features being different from the first set of one or more image features.

20. The method of claim 19, further comprising:
updating, using the one or more processing units of the machine, an initial dataset based at least on data associated with the augmented image, the initial dataset comprising the data associated with the initial image.
